(19) United States
(12) Patent Application Publication
(10) Pub. No.: US 2022/0404237 A1
(43) Pub. Date: Dec. 22, 2022

(54) MOVING AND CLAMPING DEVICE, AND BLADE HOLDER

(71) Applicant: Leica Biosystems Nussloch GmbH, Nussloch (DE)

(72) Inventor: Zheguang FAN, Pudong, Shanghai (CN)

(21) Appl. No.: 17/776,000

(22) PCT Filed: Nov. 11, 2019
(86) PCT No.: PCT/CN2019/117134

§ 371 Date: May 11, 2022

(51) Int. Cl. G01N 1/06

(52) U.S. Cl. CPC G01N 1/06; G01N 2001/061; G01N 2001/066

(57) ABSTRACT

The present disclosure provides a moving and clamping device (200) for a blade holder (100) of a microtome. The blade holder (100) includes a blade receptacle (120) configured to receive and clamp a blade. The moving and clamping device (200) includes a rotary member (210) and a clamping member (220). The rotary member (210) is configured to drive the blade receptacle (120) to move in a direction perpendicular to a rotating axis of the rotary member (210), and the clamping member (220) is configured to be movable in the rotating axis of the rotary member (210), so as to operatively clamp or release the blade receptacle (120). The rotary member (210) is rotatably fitted over the clamping member (220). The present disclosure further provides a blade holder (100).

### FIELD

The present disclosure relates to a technical field of microtomes, and more particularly to a moving and clamping device, and a blade holder.

### BACKGROUND

In the related art, a blade holder is used in a microtome. The blade holder is a mechanical component used to hold a blade. In order to fully use the whole length of the blade, a user needs to slide the blade holder laterally during use. The user needs to release the blade, move a blade receptacle containing the blade relative to a base of the blade holder to a desired positon, and then clamp the blade manually, which is laboursome, causes wearing of components of the blade holder, and results in uneven distribution of a clamping force.

### SUMMARY

Embodiments of the present disclosure seek to solve at least one of the problems existing in the related art to at least some extent.

Embodiments of a first aspect of the present disclosure provide a moving and clamping device for a blade holder of a microtome. The blade holder includes a blade receptacle configured to receive and clamp a blade. The moving and clamping device includes a rotary member and a clamping member. The rotary member is configured to drive the blade receptacle to move in a direction perpendicular to a rotating axis of the rotary member, and the clamping member is configured to be movable in the rotating axis of the rotary member, so as to operatively clamp or release the blade receptacle. The rotary member is rotatably fitted over the clamping member.

In the moving and clamping device according to embodiments of the present disclosure, by providing the rotary member rotatably fitted over the clamping member, the moving and clamping device can realize integration of the moving structure and clamping structure while ensuring that the moving structure can move the blade receptacle and the clamping structure can clamp the blade receptacle independently, thereby facilitating miniaturization of the blade holder.

In some embodiments, the rotary member includes a gear portion, the blade receptacle includes a rack portion, and the gear portion of the rotary member is configured to mesh with the rack portion of the blade receptacle, such that the rotary member is able to drive the blade receptacle to move in an extending direction of the rack portion.

In some embodiments, the rotary member includes a pulley portion fixedly connected to the gear portion and coaxially arranged with the gear portion. Thus, the pulley portion can be driven to cause the gear portion to rotate, so as to achieve movement of the blade receptacle.

In some embodiments, the moving and clamping device further includes a first electric motor provided with a first output shaft; and a driving pulley connected to an end of the first output shaft of the first electric motor, and drivingly connected to the pulley portion of the rotary member through a belt. Thus, the rotary member can be driven by the first electric motor, the movement of the blade receptacle can be motorized, and the labor intensity can be greatly alleviated.

In some embodiments, the rotary member includes another gear portion fixedly connected to the gear portion and coaxially arranged with the gear portion. Thus, said another gear portion can be driven to cause the gear portion to rotate, so as to achieve movement of the blade receptacle.

In some embodiments, the moving and clamping device further includes a first electric motor provided with a first output shaft; and a driving gear connected to an end of the first output shaft of the first electric motor, and capable of meshing with the another gear portion of the rotary member. Thus, the rotary member can be driven by the first electric motor, the movement of the blade receptacle can be motorized, and the labor intensity can be greatly alleviated.

In some embodiments, the blade receptacle defines an accommodating groove with an opening, the clamping member includes an engagement portion and a shaft portion connected to the engagement portion, the engagement portion is received in the accommodating groove, the shaft portion extends out of the accommodating groove through the opening, the gear portion of the rotary member is fitted over the shaft portion of the clamping member, and the shaft portion is movable along the rotating axis of the rotary member to operatively drive the engagement portion to abut against or move away from a wall of the accommodating groove, so as to clamp or release the blade receptacle.

In some embodiments, the clamping member includes an actuation portion defining a cavity with a first inclined face, the moving and clamping device further includes a wedge with a second inclined face configured to cooperate with the first inclined face of the cavity, such that when the wedge moves in a direction perpendicular to the rotating axis, the movement of the wedge in the direction perpendicular to the rotating axis is able to be converted into movement of the actuation portion in the rotating axis. Thus, the wedge can be driven to cause the clamping member to clamp or release the blade receptacle.

In some embodiments, the moving and clamping device further includes a housing defining a first chamber and a second chamber in fluid communication with the first chamber and extending in the rotating axis of the rotary member, the wedge is received in the first chamber and movable in the direction perpendicular to the rotating axis of the rotary member, and the actuation portion is at least partially received in the second chamber and movable along the second chamber. Thus, the movement of the clamping member can be stably guided by the second chamber of the housing, facilitating uniform distribution of a clamping force.

In some embodiments, the moving and clamping device further includes a spindle rotatably supported at two opposite walls of the housing in the direction perpendicular to the rotating axis direction of the rotary member, the spindle is provided with an external thread, the wedge is provided with an internal thread mated with the external thread of the second shaft, such that the spindle is able to be fitted with the wedge and drive the wedge to move in the direction perpendicular to the rotating axis direction.

In some embodiments, the moving and clamping device further includes a second electric motor having a second output shaft, the second output shaft is fixedly connected to the spindle, or the second output shaft and the spindle is formed into one piece. Thus, the clamping member can be driven by the second electric motor, the clamping of the blade receptacle can be motorized, and the labor intensity for the user can be greatly alleviated.

In some embodiments, the accommodating groove and the opening extend through the blade receptacle in the extending direction of the rack portion of the blade receptacle. Thus, when the blade receptacle moves along the extending direction of the rack portion, the accommodating groove slides along the extending direction of the rack portion relative to the engagement portion of the clamping member, that is, the clamping member will not interfere with the movement of the blade receptacle.

In some embodiments, a sectional area of the opening along the extending direction of the reack portion of the blade receptacle is smaller than a sectional area of the accommodating groove along the extending direction of the rack portion of the blade receptacle. Thus, the accommodating groove and the opening can constitute a T-shaped slot, and the engagement portion of the clamping member can abut against or move away from a wall of the accommodating groove adjacent to the opening, thereby achieving clamping or releasing of the blade receptacle.

In some embodiments, the rack portion is provided at each of two opposite walls within the opening, and the gear portion of the rotary member is received in the opening and meshes with the two rack portions. Thus, the gear portion of the rotary member can be stably supported and rotated between the rack portions of the blade receptacle, thereby improving stability of the moving and clamping device.

Embodiments of a second aspect of the present disclosure provide a blade holder for a microtome. The blade holder includes a base, a blade receptacle, a pivoting part, and a moving and clamping device according to any one of the above-described embodiments. The blade receptacle is configured to receive and clamp a blade and defining a guide slot. The pivoting part is provided with a guide rail capable of being fitted with the guide slot, the blade receptacle is able to be slidably mounted to the pivoting part in an extending direction of the guide rail, and the pivoting part is mounted to the base and pivotal around the extending direction of the guide rail. Thus, the moving and clamping device is able to move the blade receptacle along the guide rail of the pivoting part and clamp the blade receptacle against the pivoting part.

In the blade holder according to embodiments of the present disclosure, by providing the moving and clamping device, the moving and clamping device can realize integration of the moving structure and clamping structure while ensuring that the moving structure can move the blade receptacle and the clamping structure can clamp the blade receptacle independently, thereby facilitating miniaturization of the blade holder; the clamping of the blade receptacle can be motorized, the movement of the blade receptacle can be motorized, and the labor intensity can be greatly alleviated; the wearing of the moving and clamping device can be greatly alleviated, thereby prolong the service life of the blade holder.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a perspective view of a blade holder according to an embodiment of the present disclosure.

FIG. 2 is a schematic view of a moving and clamping device according to an embodiment of the present disclosure.

FIG. 3 is a partially enlarged view of the moving and clamping device shown in FIG. 2.

FIG. 4 is a perspective view of the moving and clamping device shown in FIG. 2.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the specification, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

In the description of the present disclosure, it should be understood that, unless specified or limited otherwise, the terms “mounted,” “connected,” and “coupled” and variations thereof are used broadly and encompass such as mechanical or electrical mountings, connections and couplings, also can be inner mountings, connections and couplings of two components, and further can be direct and indirect mountings, connections, and couplings, which can be understood by those skilled in the art according to the detail embodiment of the present disclosure.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present invention, the term “a plurality of” means two or more than two, unless specified otherwise.

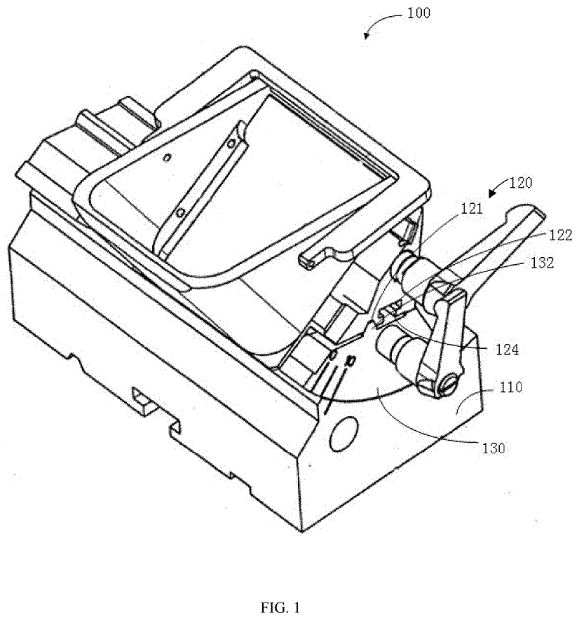

A moving and clamping device 200 for a blade holder 100 of a microtome according to embodiments of the present disclosure will be described in detail below with reference to FIGS. 1-4. The orthogonal XYZ-axis is illustrated in order to facilitate the description and determine the directions. In which, the positive direction of the X-axis is the right direction and the negative direction of the X-axis is the left direction; the positive direction of the Y-axis is the rear direction and the negative direction of the Y-axis is the front direction; the positive direction of the Z-axis is the up direction and the negative direction of the Z-axis down direction.

According to at least one embodiment of the present disclosure, the moving and clamping device 200 for a blade holder 100 of a microtome will be described below with reference to FIGS. 1 to 4.

As illustrated in FIG. 1, the blade holder 100 generally includes a blade receptacle 120 configured to receive and clamp a blade.

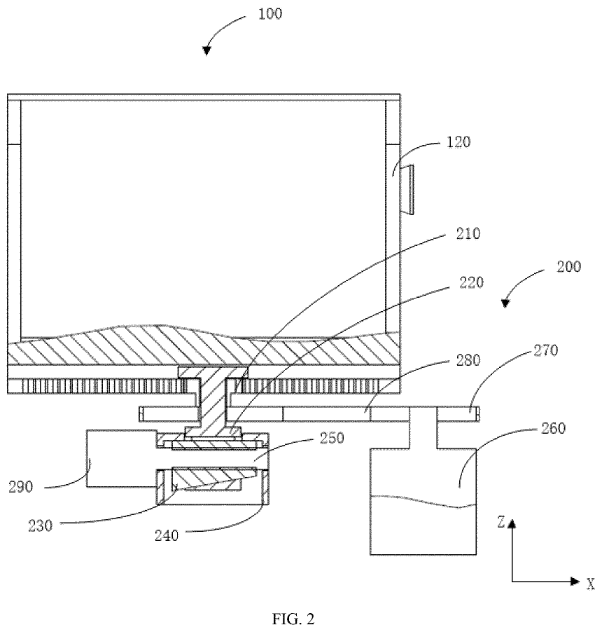

As illustrated in FIG. 2, the moving and clamping device 200 includes a rotary member 210 configured to drive the blade receptacle 120 to move in a direction perpendicular to a rotating axis of the rotary member 210; and a clamping member 220 configured to be movable in the rotating axis of the rotary member 210, so as to operatively clamp or release the blade receptacle 120, in which the rotary member 210 is rotatably fitted over the clamping member 220.

In the moving and clamping device 200 according to embodiments of the present disclosure, by providing the rotary member 210 rotatably fitted over the clamping member 220, the moving and clamping device 200 can realize integration of the moving structure and clamping structure while ensuring that the moving structure can move the blade receptacle 120 and the clamping structure can clamp the blade receptacle 120 independently, thereby facilitating miniaturization of the blade holder 100.

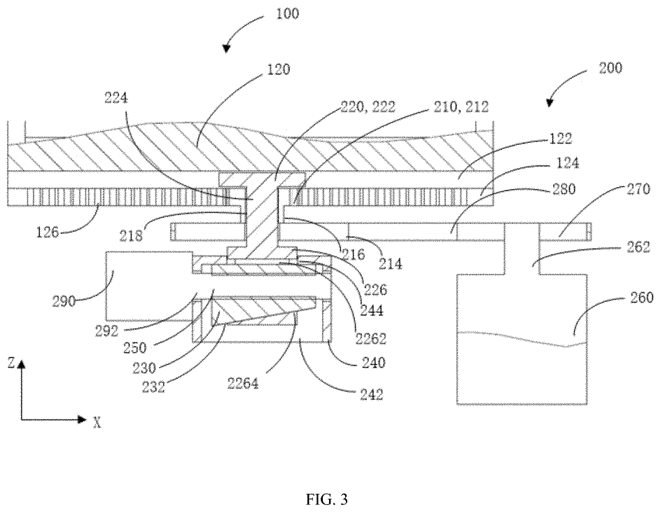

In some embodiments, as illustrated in FIG. 3, the rotary member 210 includes a gear portion 212, the blade receptacle 120 includes a rack portion 126, and the gear portion 212 of the rotary member 210 is configured to mesh with the rack portion 126 of the blade receptacle 120, such that the rotary member 210 is able to drive the blade receptacle 120 to move in an extending direction of the rack portion 126.

It could be understood that, the axis of the gear portion 212 defines the rotating axis of the rotary member 210, an extending direction of the rack portion 126 of the blade receptacle 120 coincides with the direction perpendicular to the rotating axis of the rotary member 210, and thus the extending direction of the rack portion 126 of the blade receptacle 120 defines a moving direction of the blade receptacle 120.

In some embodiments, as illustrated in FIG. 3, the rotary member 210 includes a pulley portion 214 fixedly connected to the gear portion 212 and coaxially arranged with the gear portion 212. Thus, the pulley portion 214 can be driven to cause the gear portion to rotate, so as to achieve movement of the blade receptacle 120.

In some embodiments, as illustrated in FIG. 3, the pulley portion 214 has a diameter larger than a diameter of the gear portion 212. Thus, the gear portion 212 can be driven by operating the pulley portion 214 with less force demand, such that labor intensity can be alleviated when a user operates the pulley portion 214 of the rotary member 210 manually.

In some embodiments, as illustrated in FIG. 3, the rotary member 210 further includes a connection portion 216 connected between the gear portion 212 and the pulley portion 214. Thus, the gear portion 212 and the pulley portion 214 are spaced apart along the rotating axis of the rotary member 210, so as to prevent the pulley portion 214 from interfering with the meshed gear portion 212 and the rack portion 126, thereby improving operational stability of the moving and clamping device 200.

In some embodiments, as illustrated in FIG. 3, the moving and clamping device 200 further includes a first electric motor 260 and a driving pulley 270. The first electric motor 260 is provided with a first output shaft 262, and the driving pulley 270 is connected to an end of the first output shaft 262 of the first electric motor 260 and drivingly connected to the pulley portion 214 of the rotary member 210 through a belt 280. Thus, the rotary member 210 can be driven by the first electric motor 260, the movement of the blade receptacle 120 can be motorized, and the labor intensity can be greatly alleviated.

In some alternative embodiments, the rotary member 210 includes another gear portion 214′ fixedly connected to the gear portion 212 and coaxially arranged with the gear portion 212. Thus, said another gear portion 214′ can be driven to cause the gear portion 212 to rotate, so as to achieve movement of the blade receptacle 120.

In some alternative embodiments, the moving and clamping device 200 further includes a first electric motor 260 and a driving gear 270′. The first electric motor 260 is provided with a first output shaft 262; and the driving gear 270′ is connected to an end of the first output shaft 262 of the first electric motor 260 and capable of meshing with the another gear portion of the rotary member 210.

Thus, the rotary member 210 can be driven by the first electric motor 260, the movement of the blade receptacle 120 can be motorized, and the labor intensity can be greatly alleviated.

In some embodiments, as illustrated in FIGS. 1 and 3, the blade receptacle 120 defines an accommodating groove 122 with an opening 124, the clamping member 220 includes an engagement portion 222 and a shaft portion 224 connected to the engagement portion 222, the engagement portion 222 is received in the accommodating groove 122, the shaft portion 224 extends out of the accommodating groove 122 through the opening 124, the gear portion 212 of the rotary member 210 is fitted over the shaft portion 224 of the clamping member 220, and the shaft portion 224 is movable along the rotating axis of the rotary member 210 to operatively drive the engagement portion 222 to abut against or move away from a wall of the accommodating groove 122, so as to clamp or release the blade receptacle 120.

It could be understood that, a space of the accommodating groove 122 in the rotating axis of the rotary member 210 is larger than a thickness of the engagement portion 222 of the clamping member 220, such that the engagement portion 222 can move in the rotating axis of the rotary member 210 within the accommodating groove 122.

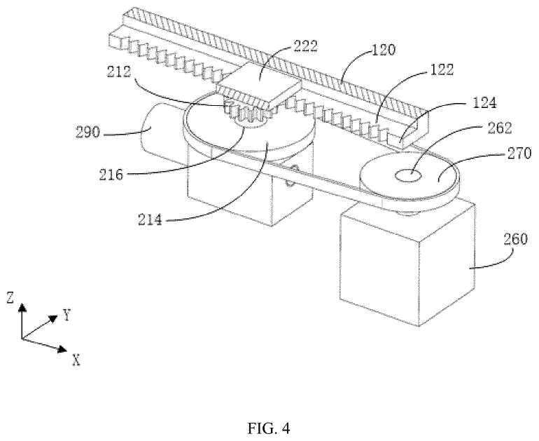

In some embodiments, as illustrated in FIGS. 3 and 4, the clamping member 220 includes an actuation portion 226 defining a cavity 2262 with a first inclined face 2264, the moving and clamping device 200 further includes a wedge 230 received in the cavity 2262 of the actuation portion 226 and provided with a second inclined face 232 configured to cooperate with the first inclined face 2264 of the cavity 2262, such that when the wedge 230 moves in a direction perpendicular to the rotating axis, the movement of the wedge 230 in the direction perpendicular to the rotating axis is able to be converted into movement of the actuation portion 226 in the rotating axis. Thus, the wedge 230 can be driven to cause the clamping member 220 to clamp or release the blade receptacle 120.

In some embodiments, as illustrated in FIGS. 3 and 4, the moving and clamping device 200 further includes a housing 240 defining a first chamber 242 and a second chamber 244 in fluid communication with the first chamber 242 and extending in the rotating axis of the rotary member 210, the wedge 230 is received in the first chamber 242 and movable in the direction perpendicular to the rotating axis of the rotary member 210, and the actuation portion 226 is at least partially received in the second chamber 244 and movable along the second chamber 244. Thus, the movement of the clamping member 220 can be stably guided by the second chamber 244 of the housing 240, facilitating uniform distribution of a clamping force.

In some embodiments, as illustrated in FIGS. 3 and 4, the moving and clamping device 200 further includes a spindle 250 rotatably supported at two opposite walls of the housing 240 in the direction perpendicular to the rotating axis direction of the rotary member 210, the spindle 250 is provided with an external thread, the wedge 230 is provided with an internal thread mated with the external thread of the spindle 250, such that the spindle 250 is able to be fitted with the wedge 230 and drive the wedge 230 to move in the direction perpendicular to the rotating axis direction.

It could be understood that, the wedge 230 and the spindle 250 can constitute a ball screw pair, thus a position of the wedge 230 can be well maintained after the wedge 230 is moved to a desired position, and the wearing of the moving and clamping device 200 can be greatly alleviated.

In some embodiments, as illustrated in FIGS. 3 and 4, the moving and clamping device 200 further includes a second electric motor 290 having a second output shaft 292, the second output shaft 292 is fixedly connected to the spindle 250, or the second output shaft 292 and the spindle 250 is formed into one piece. Thus, the clamping member 220 can be driven by the second electric motor 290, the clamping of the blade receptacle 120 can be motorized, and the labor intensity for the user can be greatly alleviated.

In some embodiments, as illustrated in FIGS. 3 and 4, the accommodating groove 122 and the opening 124 extend through the blade receptacle 120 in the extending direction of the rack portion 126 of the blade receptacle 120. Therefore, when the blade receptacle 120 moves along the extending direction of the rack portion 126, the accommodating groove 122 can slide along the extending direction of the rack portion 126 relative to the engagement portion 222 of the clamping member 220. That is, the clamping member 220 will not interfere with the movement of the blade receptacle 120.

In some embodiments, as illustrated in FIG. 3, a sectional area of the opening 124 along the extending direction of the rack portion 126 of the blade receptacle 120 is smaller than a sectional area of the accommodating groove 122 along the extending direction of the rack portion 126 of the blade receptacle 120. Thus, the accommodating groove 122 and the opening 124 can constitute a T-shaped slot, and the engagement portion 222 of the clamping member 220 can abut against or move away from a wall of the accommodating groove 122 adjacent to the opening 124, thereby achieving clamping or releasing of the blade receptacle 120.

In some embodiments, as illustrated in FIGS. 1 and 3, the rack portion 126 is provided at each of two opposite walls within the opening 124, and the gear portion 212 of the rotary member 210 is received in the opening 124 and meshes with the two rack portions 126. Thus, the gear portion 212 of the rotary member 210 can be stably supported and rotated between the rack portions 126 of the blade receptacle 120, thereby improving stability of the moving and clamping device 200.

According to at least one embodiments of the present disclosure, a blade holder 100 for a microtome includes a base 110, a blade receptacle 120, a pivoting part 130 and a moving and clamping device 200 according to any one of the above-described embodiments. The blade receptacle 120 is configured to receive and clamp a blade and defining a guide slot 121. The pivoting part 130 is provided with a guide rail 132 capable of being fitted with the guide slot 121, the blade receptacle 120 is able to be slidably mounted to the pivoting part 130 in an extending direction of the guide rail 132, and the pivoting part 130 is mounted to the base 110 and pivotal around the extending direction of the guide rail 132. Thus, the moving and clamping device 200 is able to move the blade receptacle 120 along the guide rail 132 of the pivoting part 130 and clamp the blade receptacle 120 against the pivoting part 130.

It could be understood that, the second electric motor 290 and the housing 240 may be fixedly connected to the pivoting part 130, and the first electric motor 260 may be fixedly connected to the pivoting part 130. In some examples, the structure of the housing 240 may be integrated into the pivoting part 130, the first and second electric motors 260, 290 may be received in the pivoting part 130, thereby facilitating miniaturization of the blade holder 100.

In at least one alternative embodiment of the present embodiment, a blade holder 100 for a microtome includes a base 110, a blade receptacle 120, and a moving and clamping device 200 according to any one of the above-described embodiments. The blade receptacle 120 is configured to receive and clamp a blade and defining a guide slot 121. The base 110 is provided with a guide rail 132 capable of being fitted with the guide slot 121, and the blade receptacle 120 is able to be slidably mounted to the base in an extending direction of the guide rail 132. Thus, the moving and clamping device 200 is able to move the blade receptacle 120 along the guide rail 132 of the base 110 and clamp the blade receptacle 120 against the base 110.

It could be understood that, the second electric motor 290 and the housing 240 may be fixedly connected to the base 110, and the first electric motor 260 may be fixedly connected to the base 110. In some examples, the structure of housing 240 may be integrated into the base 110, and the first and second electric motors 260, 290 may be received in the base 110, thereby facilitating miniaturization of the blade holder 100.

In the blade holder 100 according to embodiments of the present disclosure, by providing the moving and clamping device 200, the moving and clamping device 200 can realize integration of the moving structure and clamping structure while ensuring that the moving structure can move the blade receptacle 120 and the clamping structure can clamp the blade receptacle 120 independently, thereby facilitating miniaturization of the blade holder 100; the clamping of the blade receptacle 120 can be motorized, the movement of the blade receptacle 120 can be motorized, and the labor intensity can be greatly alleviated; the wearing of the moving and clamping device 200 can be greatly alleviated, thereby prolong the service life of the blade holder 100.

As illustrated in FIGS. 1 to 4, according to a specific embodiment of the present disclosure, the blade holder 100 includes a base 110, a blade receptacle 120, and a pivoting part 130.

The blade receptacle 120 is configured to receive a blade and clamp the blade. The blade receptacle 120 is mounted to the pivoting part 130 and slidable in a left and right direction relative to the pivoting part 130. Specifically, the pivoting part 130 is provided with a guide rail 132 extending in the left and right direction, and the blade receptacle 120 defines a guide slot 121 fitted with the guide rail 132, such that the blade receptacle 120 is slidable along the left and right direction relative to the pivoting part 130. The pivoting part 130 is mounted to the base 110 and pivotal about the left and right direction relative to the base 110.

The blade holder 100 further includes a moving and clamping device 200. The moving and clamping device 200 includes a rotary member 210 and a clamping member 220. The rotary member 210 is configured to drive the blade receptacle 120 to move in the left and right direction, and the clamping member 220 is configured to be movable in a direction perpendicular to the left and right direction, so as to operatively clamp or release the blade receptacle 120.

Specifically, the rotary member 210 includes a gear portion 212, a pulley portion 214, and a connection portion 216 fixedly connected between the gear portion 212 and the pulley portion 214. The gear portion 212 and the pulley portion 214 are coaxially arranged, such that a rotating axis of the rotary member 210 coincides with axes of the gear portion and the pulley portion 214. The rotary member 210 further defines a through hole 218 extending through the gear portion 212, the pulley portion 214 and the connection portion 216 along the rotating axis of the rotary member 210.

The clamping member 220 includes an engagement portion 222, a shaft portion 224, and an actuation portion 226. The engagement portion 222 is a rectangular plate. The shaft portion 224 is a cylinder whose axis is parallel to the rotating axis of the rotary member 210. The actuation portion 226 is a cylinder whose axis extends in the left and right direction, i.e. in a direction perpendicular to the rotating axis of the rotary member 210. The engagement portion 222 and the actuation portion 226 are fixedly connected to two ends of the shaft portion 224, such that the clamping member 220 is substantially a T-shaped part. The shaft portion 224 passes through the through hole 218 of the rotary member 210, i.e. the rotary member 210 is rotatably fitted over the clamping member 220. The actuation portion 226 defines a cavity 2262 with a first inclined face 2264, and the first inclined face 2264 obliquely extends upwards from left to right.

The blade receptacle 120 defines an accommodating groove 122 with an opening 124. The accommodating groove 122 and the opening 124 extend through the blade receptacle 120 in the left and right direction, and a sectional area of the opening 124 along the left and right direction is smaller than a sectional area of the accommodating groove 122 along the left and right direction, i.e. the accommodating groove 122 and the opening 124 substantially constitute a T-shaped slot. The engagement portion 222 is received in the accommodating groove 122, and the shaft portion 224 extends out of the accommodating groove 122 through the opening 124. The shaft portion 224 is movable along the rotating axis of the rotary member 210 to operatively drive the engagement portion 222 to abut against or move away from a wall of the accommodating groove 122, so as to clamp or release the blade receptacle 120.

The blade receptacle 120 includes a rack portion 126 extending in the left and right direction, and the rack portion 126 is provided at each of two opposite walls within the opening 124, and the gear portion 212 of the rotary member 210 is received in the opening 124 and meshes with the two rack portions 126, such that the rotary member 210 can stably drive the blade receptacle 120 to move along an extending direction of the rack portion 126.

The moving and clamping device 200 further includes a wedge 230, and the wedge 230 is truncated eccentric cone. The wedge 230 is received in the cavity 2262 of the actuation portion 226, and provided with a second inclined face 232 configured to cooperate with the first inclined face 2264 of the cavity 2262 of the actuation portion 226, such that when the wedge 230 moves in the left and right direction, the movement of the wedge 230 in the left and right direction is able to be converted into movement of the actuation portion 226 in the rotating axis.

The moving and clamping device 200 includes a housing 240 defining a first chamber 242 and a second chamber 244 in fluid communication with the first chamber 242, the wedge 230 is received in the first chamber 242 and is movable in the left and right direction, and the actuation portion 226 is at least partially received in the second chamber 244 and movable along the second chamber 244, and the second chamber 244 extends in the rotating axis of the rotary member 210.

The moving and clamping device 200 includes a spindle 250, and the spindle 250 is rotatably supported at two opposite walls of the housing 240 in the left and right direction. The spindle 250 is provided with an external thread, the wedge 230 is provided with an internal thread mated with the external thread of the spindle 250, such that the spindle 250 is able to be fitted with the wedge 230 and drive the wedge 230 to move in the left and right direction.

The moving and clamping device 200 includes a first electric motor 260 provided with a first output shaft 262; and a driving pulley 270 connected to an end of the first output shaft 262 of the first electric motor 260 and drivingly connected to the pulley portion 214 of the rotary member 210 through a belt 280, such that the first electrical motor can drive the rotary member 210 to rotate through the driving pulley 270, the belt 280, and the pulley portion 214 of the rotary member 210.

The moving and clamping device 200 includes a second electric motor 290 having a second output shaft 292, the second output shaft 292 is fixedly connected to the spindle 250, or the second output shaft 292 and the spindle 250 is formed into one piece, such that the second electric motor 290 can drive the wedge 230 to move in the left and right direction through the spindle 250.

An operation process of the blade holder 100 will be briefly described below.

When the blade receptacle 120 needs to move in the left and right direction, the second electric motor 290 is activated to rotate to drive the wedge 230 to move to the left, such that the second inclined face 232 of the wedge 230 is disengaged from the first inclined face 2264 of the actuation portion 226. The first electric motor 260 is activated to rotate to drive the rotary member 210 to rotate, the rotary member 210 drive the blade receptacle 120 to move in the left and right direction along the pivoting part 130. When the blade receptacle 120 reaches a desired position, the first electric motor 260 is deactivated, and the second electric motor 290 is activated to rotate reversely, such that the wedge 230 is driven to move to the right. The second inclined face 232 of the wedge 230 comes into contact with the second inclined face 232 of the actuation portion 226, and the clamping member 220 is driven to move downwards to cause the engagement portion 222 to tightly press the lower wall of the accommodating groove 122, such that the blade receptacle 120 is clamped on the pivoting part 130. The second electric motor 290 is then deactivated.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A moving and clamping device (200) for a blade holder (100) of a microtome, the blade holder (100) comprising a blade receptacle (120) configured to receive and clamp a blade, the moving and clamping device (200) comprising:
a rotary member (210) configured to drive the blade receptacle (120) to move in a direction perpendicular to a rotating axis of the rotary member (210); and
a clamping member (220) configured to be movable in the rotating axis of the rotary member (210), so as to operatively clamp or release the blade receptacle (120), wherein the rotary member (210) is rotatably fitted over the clamping member (220).

2. The moving and clamping device (200) according to claim 1, wherein the rotary member (210) comprises a gear portion (212), the blade receptacle (120) comprises a rack portion (126), and the gear portion (212) of the rotary member (210) is configured to mesh with the rack portion (126) of the blade receptacle (120), such that the rotary member (210) is able to drive the blade receptacle (120) to move in an extending direction of the rack portion (126).

3. The moving and clamping device (200) according to claim 2, wherein the rotary member (210) comprises a pulley portion (214) fixedly connected to the gear portion (212) and coaxially arranged with the gear portion (212).

4. The moving and clamping device (200) according to claim 3, further comprising:
a first electric motor (260) provided with a first output shaft (262); and
a driving pulley (270) connected to an end of the first output shaft (262) of the first electric motor (260), and drivingly connected to the pulley portion (214) of the rotary member (210) through a belt (280).

5. The moving and clamping device (200) according to claim 2, wherein the rotary member (210) comprises another gear portion (214′) fixedly connected to the gear portion (212) and coaxially arranged with the gear portion (212).

6. The moving and clamping device (200) according to claim 5, further comprising:
a first electric motor (260) provided with a first output shaft (262); and
a driving gear (270′) connected to an end of the first output shaft (262) of the first electric motor (260), and capable of meshing with the another gear portion (214′) of the rotary member (210).

7. The moving and clamping device (200) according to claim 2, wherein the blade receptacle (120) defines an accommodating groove (122) with an opening (124), the clamping member (220) comprises an engagement portion (222) and a shaft portion (224) connected to the engagement portion (222), the engagement portion (222) is received in the accommodating groove (122), the shaft portion (224) extends out of the accommodating groove (122) through the opening (124), the gear portion (212) of the rotary member (210) is fitted over the shaft portion (224) of the clamping member (220), and the shaft portion (224) is movable along the rotating axis of the rotary member (210) to operatively drive the engagement portion (222) to abut against or move away from a wall of the accommodating groove (122), so as to clamp or release the blade receptacle (120).

8. The moving and clamping device (200) according to claim 7, wherein the clamping member (220) includes an actuation portion (226) defining a cavity (2262) with a first inclined face (2264), the moving and clamping device (200) further comprises a wedge (230) received in the cavity (2262) of the actuation portion (226) and provided with a second inclined face (232) configured to cooperate with the first inclined face (2264) of the cavity (2262), such that when the wedge (230) moves in a direction perpendicular to the rotating axis, the movement of the wedge (230) in the direction perpendicular to the rotating axis is able to be converted into movement of the actuation portion (226) in the rotating axis.

9. The moving and clamping device (200) according to claim 8, further comprising a housing (240) defining a first chamber (242) and a second chamber (244) in fluid communication with the first chamber (242) and extending in the rotating axis of the rotary member (210), the wedge (230) being received in the first chamber (242) and movable in the direction perpendicular to the rotating axis of the rotary member (210), and the actuation portion (226) being at least partially received in the second chamber (244) and movable along the second chamber (244).

10. The moving and clamping device (200) according to claim 9, further comprising a spindle (250) rotatably supported at two opposite walls of the housing (240) in the direction perpendicular to the rotating axis direction of the rotary member (210), the spindle (250) being provided with an external thread, the wedge (230) being provided with an internal thread mated with the external thread of the spindle (250), such that the spindle (250) is able to be fitted with the wedge (230) and drive the wedge (230) to move in the direction perpendicular to the rotating axis direction.

11. The moving and clamping device (200) according to claim 10, further comprising a second electric motor (290) having a second output shaft (292), the second output shaft (292) being fixedly connected to the spindle (250), or the second output shaft (292) and the spindle (250) being formed into one piece.

12. The moving and clamping device (200) according to claim 7, wherein the accommodating groove (122) and the opening (124) extend through the blade receptacle (120) in the extending direction of the rack portion (126) of the blade receptacle (120).

13. The moving and clamping device (200) according to claim 12, wherein a sectional area of the opening (124) along the extending direction of the rack portion (126) of the blade receptacle (120) is smaller than a sectional area of the accommodating groove (122) along the extending direction of the rack portion (126) of the blade receptacle (120).

14. The moving and clamping device (200) according to claim 7, wherein the rack portion (126) is provided at each of two opposite walls within the opening (124), and the gear portion (212) of the rotary member (210) is received in the opening (124) and meshes with the two rack portions (126).

15. A blade holder (100) for a microtome, comprising:
a base (110);
a blade receptacle (120) configured to receive and clamp a blade and defining a guide slot (121);
a pivoting part (130) provided with a guide rail capable of being fitted with the guide slot (121), the blade receptacle (120) being able to be slidably mounted to the pivoting part (130) in an extending direction of the guide rail (132), the pivoting part (130) being mounted to the base (110) and pivotal around the extending direction of the guide rail (132); and
a moving and clamping device (200), such that the moving and clamping device (200) is able to move the blade receptacle (120) along the guide rail (132) of the pivoting part (130) and clamp the blade receptacle (120) against the pivoting part (130),
wherein the moving and clamping device (200) comprises:
a rotary member (210) configured to drive the blade receptacle (120) to move in a direction perpendicular to a rotating axis of the rotary member (210); and
a clamping member (220) configured to be movable in the rotating axis of the rotary member (210), so as to operatively clamp or release the blade receptacle (120),
wherein the rotary member (210) is rotatably fitted over the clamping member (220).
